(19) United States
(12) Patent Application Publication
(10) Pub. No.: US 2017/0071195 A1
(43) Pub. Date: Mar. 16, 2017

(54) EXTENDED LIFE ANIMAL-REPELLING SPRAY CHEMICAL COMPOSITION

(71) Applicant: MINT-X LLC, College Point, NY (US)

(72) Inventors: Joseph A. Dussich, JR., New York, NY (US); James A. Dussich, New York, NY (US)

(21) Appl. No.: 15/255,747

(22) Filed: Sep. 2, 2016

Related U.S. Application Data
(60) Provisional application No. 62/216,657, filed on Sep. 10, 2015.

(51) Int. Cl. A01N 25/02; A01N 37/10; A01N 31/06; A01N 65/28; A01N 65/22

(52) U.S. Cl. CPC A01N 25/02; A01N 65/28; A01N 65/22; A01N 31/06; A01N 37/10

(57) ABSTRACT

A spray-on chemical composition that repels animals, includes a liquid carrier. The spray-on chemical composition also includes at least one odorant compound. The at least one odorant compound is selected from the group consisting of a salicylic acid ester, menthol, corn mint oil, eucalyptus oil, camphor oil, and combinations thereof. The spray-on chemical composition also includes at least one scent extender which includes at least one cyclodextrin compound. Another spray-on chemical composition that repels animals and a spray-on chemical composition based method for repelling animals are also described.

### CROSS-REFERENCE TO RELATED APPLICATIONS

This application claims priority to and the benefit of co-pending U.S. provisional patent application Ser. No. 62/216,657, EXTENDED LIFE ANIMAL-REPELLING SPRAY CHEMICAL COMPOSITION, filed Sep. 10, 2015, which application is incorporated herein by reference in its entirety.

### FIELD OF THE APPLICATION

The application relates to a chemical composition that repels animals and particularly to a spray-on chemical composition that repels animals.

### BACKGROUND

In many cities, the disposal of residential garbage is carried out as follows. Each household puts its garbage into a polyethylene garbage bag designated by the city and places the filled bag in a designated spot outside the house on an appointed day for collection. The garbage bags are then collected by city garbage trucks.

A problem associated with this conventional disposal method is that garbage bags left outside are often ripped open by foraging animals like cats, dogs, rats, squirrels, opossums, and raccoons before garbage trucks can collect them, thereby scattering the garbage.

Additionally, home and property owners place or plant varieties of decorative plants and vegetation that foraging animals like rabbits and deer consume or damage. A number of products exist that attempt to repel such animals to prevent the consumption or damage caused by such animals.

In the prior art, repellents typically are impregnated into a powdery support, spread or sprayed directly on an article, or manufactured as a component of shaped articles having a repellent effect. A number of such animal repellents are known, but none of them is satisfactory both in terms of effect, time duration of effect, and cost.

### SUMMARY

According to one aspect, a spray-on chemical composition that repels animals, includes a liquid carrier. The spray-on chemical composition also includes at least one odorant compound. The at least one odorant compound is selected from the group consisting of a salicylic acid ester, menthol, corn mint oil, eucalyptus oil, camphor oil, and combinations thereof. The spray-on chemical composition also includes at least one scent extender which includes at least one cyclodextrin compound.

In one embodiment, the cyclodextrin compound includes an alpha-cyclodextrin.

In another embodiment, the cyclodextrin compound includes a beta-cyclodextrin.

In yet another embodiment, the cyclodextrin compound includes a hydroxypropyl-beta-cyclodextrin.

In yet another embodiment, the cyclodextrin compound includes a methyl-beta-cyclodextrin.

In yet another embodiment, the liquid carrier includes an organic solvent.

In yet another embodiment, the organic solvent includes a hydrocarbon.

In yet another embodiment, the organic solvent includes an aromatic hydrocarbon.

In yet another embodiment, the organic solvent includes isoalkanes.

In yet another embodiment, the isoalkanes includes a C7-10 isoalkanes.

In yet another embodiment, the organic solvent is present in at least 75 percent by weight of the spray-on chemical composition, the odorant compound is present in at least 5 percent by weight of the spray-on chemical composition, and the at least one scent extender is present in at least 2 percent by weight of the spray-on chemical composition.

According to another aspect, a spray-on chemical composition that repels animals, includes an organic solvent liquid carrier including isoalkanes. An odorant compound is selected from the group consisting of a salicylic acid ester, menthol, corn mint oil, eucalyptus oil, camphor oil, and combinations thereof. At least one scent extender compound is selected from the group consisting of alpha-cyclodextrin, beta-cyclodextrin, hydroxypropyl-beta-cyclodextrin; and methyl-beta-cyclodextrin and mixtures thereof.

In one embodiment, the organic solvent liquid carrier is present in at least 75 percent by weight of the spray-on chemical composition, the odorant compound is present in at least 5 percent by weight of the spray-on chemical composition, and the at least one scent extender compound is present in at least 2 percent by weight of the spray-on chemical composition.

According to yet another aspect, a spray-on chemical composition based method for repelling animals, includes: providing a spray-on chemical composition that repels animals, including a liquid carrier, at least one odorant compound, at least one odorant compound is selected from the group consisting of a salicylic acid ester, menthol, corn mint oil, eucalyptus oil, camphor oil, and combinations thereof, and at least one scent extender including at least one cyclodextrin compound; and spraying the spray-on chemical composition onto an article to repel animals, wherein the cyclodextrin compound causes an animal repelling odor generated by the spray-on chemical composition to be scent extended.

In one embodiment, the step of providing a cyclodextrin compound includes providing a cyclodextrin compound including at least one of alpha-cyclodextrin, beta-cyclodextrin, hydroxypropyl-beta-cyclodextrin; and methyl-beta-cyclodextrin.

In another embodiment, the step of providing a liquid carrier includes providing an organic solvent.

In yet another embodiment, the step of providing an organic solvent includes providing a hydrocarbon.

In yet another embodiment, the step of providing an organic solvent includes providing an aromatic hydrocarbon.

In yet another embodiment, the step of providing an organic solvent includes providing an isoalkane.

In yet another embodiment, the step of providing a chemical composition includes providing a chemical composition wherein the organic solvent is present in at least 75 percent by weight of the chemical composition, the odorant compound is present in at least 5 percent by weight of the chemical composition, and the at least one scent extender is present in at least 2 percent by weight of the chemical composition.

The foregoing and other aspects, features, and advantages of the application will become more apparent from the following description and from the claims.

### DETAILED DESCRIPTION

In U.S. Pat. No. 7,811,597, we described a synthetic resin composition which sheds an odor that keeps away domesticated animals, especially cats and dogs, and also varmints of both fur and feather, for example rats, crows, etc. The article may be made from a synthetic resin composition including a synthetic resin and from 10 to 15,000 ppm by weight of a salicylic acid ester, menthol and/or camphor. The article may also be made from a synthetic resin composition including a synthetic resin and an odorant composition containing eucalyptus oil and one or more of a salicylic acid ester, menthol and camphor. In U.S. Pat. No. 8,734,819, we described an article, such as a container or bag for garbage, or electrical wiring insulation, which repels animals such as cats, dogs, rodents, and crows. The article is made from a synthetic resin composition including a thermoplastic polymer, and from 10 to 15,000 ppm by weight of an odorant compound such as a salicylic acid ester, menthol, corn mint oil, eucalyptus oil, and camphor, and combinations thereof. Both of the '597 and '819 patents are incorporated herein by reference in their entirety for all purposes.

In many manufacturing applications, making a product which includes a synthetic resin composition as was described and claimed by the '597 patent and the '819 patent is an efficient and cost effective way to repel animals which might otherwise damage the product in the field. However, particularly when an un-treated, or insufficiently treated product or assembly becomes damaged by animals, there is a need for a repellant with the superior performance of our synthetic resin compositions which can later be applied post-production, such as in the field. Because of the performance and commercial success of the repellant properties of our formulation, it would be desirable to be able to spray-on components of our successful synthetic resin composition. Unfortunately, it was found that when applied post-production to the exterior surface of an already manufactured product (i.e. an untreated, or insufficiently treated product), that the active ingredients out-gassed too fast and while effective short term, could not protect the product longer term.

Cyclodextrins have been used in commercial products to control or suppress odors, such as in deodorants to suppress the detection of odors by the human nose. That is, cyclodextrins have been previously used to encapsulate odor generating compounds for preventing odors. While seemingly detrimental to the opposite application of intentionally emitting odors to repel animals, surprisingly, we realized that in some formulations as described hereinbelow, cyclodextrins can also be used to slow, but not stop, the release of animal repelling odors.

In co-pending U.S. patent application Ser. No. 15/241,822, SCENT EXTENDED ANIMAL-REPELLING SYNTHETIC RESIN COMPOSITION, filed Aug. 19, 2016, we described an animal repelling synthetic resin composition that includes cyclodextrins where were able to adapt the successful animal repellant odor molecules from our previous work in synthetic resin compositions, into synthetic resin compositions with scent extended animal repelling odors. The cyclodextrins, now instead of preventing the desired odors, slow the release of the animal repellant odor molecules that create the odor so that the repellant effect is scent extended by a cyclodextrin scent extender, and the animal repellant odor lasts longer. Or, a same desired odor can be achieved with less volume of the synthetic resin composition. The co-pending '822 application is incorporated herein by reference in its entirety for all purposes.

What is needed is a composition and method that can be used to spray a similar composition onto an already manufactured article, product, assembly, etc.

Cyclodextrins (sometimes called cycloamyloses) are a known family of compounds made up of sugar molecules bound together in a ring (cyclic oligosaccharides). Cyclodextrins are composed of 5 or more α-D-glucopyranoside monomer units linked 1->4, as in amylose (a fragment of starch). Typical cyclodextrins contain a number of glucose monomers ranging from six to eight monomer units in a ring, creating a cone shape, e.g., a (alpha)-cyclodextrin, a 6-membered sugar ring molecule; β(beta)-cyclodextrin, a 7-membered sugar ring molecule; and γ(gamma)-cyclodextrin, an 8-membered sugar ring molecule.

Cyclodextrins are widely used in commercial products directed to the control of odors, e.g., deodorants, typically to suppress the detection of odors by the human nose.

What is needed in the art is an animal-repelling chemical composition having improved persistence of odorant in use.

The present Application describes a spray-on chemical composition that repels animals such as rodents, opossum, raccoons, cats, dogs, deer and birds. The composition comprises a carrying agent; at least one odorant selected from the group consisting of a salicylic acid ester, menthol, corn mint oil, eucalyptus oil, and camphor, and combinations thereof; and a scent extender. In some embodiments the spray-on chemical composition described hereinbelow is contemplated to have an effective repellant use time of at least two weeks or more.

The carrier is preferably a low odor, low aromatic hydrocarbon solvent. Preferably, the solvent includes naphtha (petroleum) and light alkylate. Another major component of the solvent includes alkanes, and preferably C7-10 isoalkanes.

The scent extender typically comprises a cyclodextrin compound. A currently preferred scent extender comprises at least one of alpha-cyclodextrin, beta-cyclodextrin, hydroxypropyl-beta-cyclodextrin; and methyl-beta-cyclodextrin and mixtures thereof.

In a preferred embodiment, the chemical formulation includes, the carrying agent comprising greater than 75% by weight of the chemical composition, and preferably approximately 85%; the odorant comprises at least 2% by weight of the chemical composition, and preferably approximately 10% by weight; and the scent extender comprises at least 1% by weight, and preferably 5%.

The chemical composition is formulated using known addition and mixing procedures. A preferred method is to create a blend of odorant compounds, and then mixing in a scent extender comprising cyclodextrins to encapsulate small amounts of the blended odorant. The mixture is then mixed with a suitable carrier to maintain a solution with a consistency for spray applications.

In use, the chemical composition is suitable for application via a method selected from the group consisting of pressurized spray and liquid layer. The inclusion of a scent extender in the novel chemical composition causes the animal-repellant effect to be substantially prolonged in comparison with known animal-repellant compositions.

From the foregoing description, it will be apparent that there has been provided an improved animal-repelling chemical composition suitable for spray or liquid layer application. Variations and modifications of the herein described chemical composition will undoubtedly suggest themselves to those skilled in this art. Accordingly, the foregoing description should be taken as illustrative and not in a limiting sense.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A spray-on chemical composition that repels animals, comprising:
a liquid carrier;
at least one odorant compound, at least one odorant compound is selected from the group consisting of a salicylic acid ester, menthol, corn mint oil, eucalyptus oil, camphor oil, and combinations thereof; and
at least one scent extender comprising at least one cyclodextrin compound.

2. The spray-on chemical composition of claim 1, wherein said cyclodextrin compound comprises an alpha-cyclodextrin.

3. The spray-on chemical composition of claim 1, wherein said cyclodextrin compound comprises a beta-cyclodextrin.

4. The spray-on chemical composition of claim 1, wherein said cyclodextrin compound comprises a hydroxypropyl-beta-cyclodextrin.

5. The spray-on chemical composition of claim 1, wherein said cyclodextrin compound comprises a methyl-beta-cyclodextrin.

6. The spray-on chemical composition of claim 1, wherein said liquid carrier comprises an organic solvent.

7. The spray-on chemical composition of claim 6, wherein said organic solvent comprises a hydrocarbon.

8. The spray-on chemical composition of claim 7, wherein said organic solvent comprises an aromatic hydrocarbon.

9. The spray-on chemical composition of claim 6, wherein said organic solvent comprises isoalkanes.

10. The spray-on chemical composition of claim 9, wherein said isoalkanes comprises a C7-10 isoalkanes.

11. The spray-on chemical composition of claim 6, wherein said organic solvent is present in at least 75 percent by weight of said spray-on chemical composition, said odorant compound is present in at least 5 percent by weight of said spray-on chemical composition, and said at least one scent extender is present in at least 2 percent by weight of said spray-on chemical composition.

12. A spray-on chemical composition that repels animals, comprising:
an organic solvent liquid carrier comprising isoalkanes;
an odorant compound selected from the group consisting of a salicylic acid ester, menthol, corn mint oil, eucalyptus oil, camphor oil, and combinations thereof; and
at least one scent extender compound selected from the group consisting of alpha-cyclodextrin, beta-cyclodextrin, hydroxypropyl-beta-cyclodextrin; and methyl-beta-cyclodextrin and mixtures thereof.

13. The spray-on chemical composition of claim 12, wherein said organic solvent liquid carrier is present in at least 75 percent by weight of said spray-on chemical composition, said odorant compound is present in at least 5 percent by weight of said spray-on chemical composition, and said at least one scent extender compound is present in at least 2 percent by weight of said spray-on chemical composition.

14. A spray-on chemical composition based method for repelling animals, comprising:
providing a spray-on chemical composition that repels animals, comprising a liquid carrier, at least one odorant compound, at least one odorant compound is selected from the group consisting of a salicylic acid ester, menthol, corn mint oil, eucalyptus oil, camphor oil, and combinations thereof, and at least one scent extender comprising at least one cyclodextrin compound; and
spraying said spray-on chemical composition onto an article to repel animals, wherein said cyclodextrin compound causes an animal repelling odor generated by said spray-on chemical composition to be scent extended.

15. The method of claim 14, wherein said step of providing a cyclodextrin compound comprises providing a cyclodextrin compound comprising at least one of alpha-cyclodextrin, beta-cyclodextrin, hydroxypropyl-beta-cyclodextrin; and methyl-beta-cyclodextrin.

16. The method of claim 14, wherein said step of providing a liquid carrier comprises providing an organic solvent.

17. The method of claim 16, wherein said step of providing an organic solvent comprises providing a hydrocarbon.

18. The method of claim 16, wherein said step of providing an organic solvent comprises providing an aromatic hydrocarbon.

19. The method of claim 16, wherein said step of providing an organic solvent comprises providing an isoalkane.

20. The method of claim 16, wherein said step of providing a chemical composition comprises providing a chemical composition wherein said organic solvent is present in at least 75 percent by weight of said chemical composition, said odorant compound is present in at least 5 percent by weight of said chemical composition, and said at least one scent extender is present in at least 2 percent by weight of said chemical composition.
